(19) United States
(12) Patent Application Publication
(10) Pub. No.: US 2020/0034637 A1
(43) Pub. Date: Jan. 30, 2020

(54) Real-Time Track Asset Recognition and Position Determination

(71) Applicant: Herzog Technologies, Inc., St. Joseph, MO (US)

(72) Inventors: Lee G. Olson, Cedar Rapids, IA (US); Jeffrey J. Burnett, Cedar Rapids, IA (US); Matthew A. Schouten, Cedar Rapids, IA (US); James W. Hanlon, JR., Grapevine, TX (US); Glen F. Dargy, Shellsburg, IA (US)

(73) Assignee: Herzog Technologies, Inc., St. Joseph, MO (US)

(21) Appl. No.: 16/521,166

(22) Filed: Jul. 24, 2019

Related U.S. Application Data
(60) Provisional application No. 62/703,228, filed on Jul. 25, 2018.

(51) Int. Cl. G06K 9/00; H04N 5/247; G06K 9/62; G06F 3/14; G01C 11/00; B61K 9/08; B61D 15/12; B61L 25/02

(52) U.S. Cl. CPC G06K 9/00791; H04N 5/247; G06K 9/6201; B61L 25/025; G01C 11/00; B61K 9/08; B61D 15/12; G06F 3/14

(57) ABSTRACT

A system for real-time asset recognition and location includes an image capture and recognition system having a plurality of image capturing devices for capturing image data of an area surrounding a railroad track and a position determination system for determining a position of assets in the area surrounding the track. A processor analyzes captured image data and recognizes assets and correlates a determined position with each recognized asset. The system recognizes assets and determines positions of assets in real-time as the system is transported along a railroad track by a survey vehicle. The captured and analyzed data is stored to a data storage unit for immediate use in updating a railroad asset data base, subdivision files, or positive train control (PTC) files.

### CROSS-REFERENCE TO RELATED APPLICATIONS

This application claims the benefit of U.S. Provisional Patent Application No. 62/703,228, filed Jul. 25, 2018, the disclosure of which is hereby incorporated herein in its entirety by reference.

### FIELD

The present invention relates generally to the field of railroads, and more particularly to a system and method for recognizing assets associated with, or in proximity to, a railroad track, determining the geospatial locations or positions of those assets, and recording data and information associated with the assets and their positions.

### BACKGROUND

For safety and operational efficiency, railroads require up-to-date information of assets located on or near the railroad right-of-ways, including the position or geolocation of those assets. In addition to internal operational and safety reasons for tracking assets, the federally-mandated Positive Train Control (PTC) track verification process requires that every feature in the PTC onboard track data is verified to have an accurate position to within 2.2 meters of the position reported by a precision GPS.

Known asset recognition and detection systems used to detect and locate assets, or to verify PTC or other location databases, are generally cumbersome and

(Docket No. 541.190) labor intensive, requiring human presence and/or human input to assist in the recognition and verification of assets. In the case of verifying PTC data, the labor intensive verification process requires the moniopolization of track time that precludes railroads from otherwise using the track until the verification process is completed.

Even in the case of surveying a track to locate assets independently of PTC verification, the process is typically slow and labor intensive. For example, known methods of surveying the track and right of way—such as using a survey vehicle traversing the track or using an aerial surveillance drone—require that the data collected be transferred to a central location for post-processing. Post-processing involves a central computer analyzing the collected data in order to identify assets within the collected data. The post-processing process is itself labor intensive and typically requires human intervention to assist in identifying assets. Furthermore, post-processing introduces a lengthy delay between the data collection process and the ultimate ability to use the newly collected data and updated location data. Thus, while regular updates of asset information are necessary to timely inform railroads of assets along the right-of-way and to ensure that PTC and other location databases are current and accurate, known systems are unable to quickly and efficiently obtain and provide those needed updates.

Thus, it can be seen that there remains a need in the art for a system and method for efficiently acquiring railroad asset information and for providing that information in a timely manner.

### SUMMARY

Embodiments of the invention are defined by the claims below, not this summary. A high-level overview of various aspects of the invention are provided here for that reason, to provide an overview of the disclosure, and to introduce a selection of concepts that are further described in the detailed description section below. This summary is not intended to identify key features or essential features of the claimed subject matter, nor is it intended to be used as an aid in isolation to determine the scope of the claimed subject matter. In brief, this disclosure describes, among other things, a system and method for the acquisition of image and positional data of an area in and around a railroad track and/or railroad right-of-way and the real-time analysis and recognition of railroad features, such as railroad assets, along with their position or geolocation within that collected image and positional data. Railroad assets include, but are not limited to, crossings, signals, lights, tunnels, bridges, gates, mile posts, and other assets associated with the operation of a railroad.

In one embodiment, an image capture and recognition system and a position determination system are mounted on a survey vehicle, with each system in communication with a processor and a data storage unit on the vehicle. As the survey vehicles traverses a railroad track, the image capture and recognition system and position determination system collect data, e.g., images of areas surrounding the survey vehicle along the railroad track and corresponding positional data. The image capture and recognition system, either independently of or in conjunction with the processor, analyzes the captured image data to identify railroad assets within the image data. The captured image data is correlated with the position data from the position determination system so that each identified asset is assigned a corresponding location or position. The identified assets and the associated position or location data is stored in a data base file, as are the original collected image data and position data. Unlike systems known in the prior art, the collected data is processed in real-time on the survey vehicle, with the image capture and recognition system and position determination system working in conjunction with the processor to capture data, process data, and store data to the data storage unit. Because the data is processed in real time as the survey vehicle traverses the track, a completed database of identified assets and their corresponding positions is available immediately upon completion of a survey run. The database of identified assets and their positions may thus be immediately used to create new asset databases, to update existing asset databases, to create new PTC databases, to audit and/or update existing PTC databases and to locate deviations from prior data or identify previously unidentified assets.

In addition, the collected data is immediately available for use in ongoing railroad maintenance activities, or for use by the same survey vehicle in subsequent operation. Because the data is captured and processed in real time there is no need to submit the collected data file to a central location for post processing which requires hours, days, or even weeks of delay.

Because the image collection, processing, and position determination occurs in real-time, no post-processing of data files is required, and the captured data is available for immediate distribution and use.

### DESCRIPTION OF THE DRAWINGS

Illustrative embodiments of the invention are described in detail below with reference to the attached drawing figures, and wherein:

FIG. 1 is a perspective view of a survey vehicle and survey system for use in track data collection and real-time asset recognition and location in accordance with an exemplary embodiment of the present invention.

FIG. 2 is a rear elevational view of the survey vehicle and survey system of FIG. 1.

FIG. 3 is a top plan view of the survey vehicle and survey system of FIG. 1.

FIG. 4 is a functional block diagram illustrating the components of the survey system for use in track data collection and real-time asset recognition and location in accordance with an exemplary embodiment of the present invention.

### DETAILED DESCRIPTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

The present invention is directed to a system and method for real-time asset recognition and location using a survey system comprising an image capture and recognition system and a position determination system to capture imagery data of a railroad track and surrounding area or right-of-way, identify railroad assets in the captured imagery data, and to associate a geolocation or location with each identified asset. In operation, the survey system, comprising an image capture and recognition system and a position determination system, is attached to a survey vehicle which traverses a railroad track as the survey system captures images and identifies assets and their locations in real-time. The survey system is contained and is operational on the survey vehicle so that data files having the captured asset imagery and associated position data are immediately available for use, with no transfer of the data to a central facility or post-processing of data as is required with known asset recognition systems.

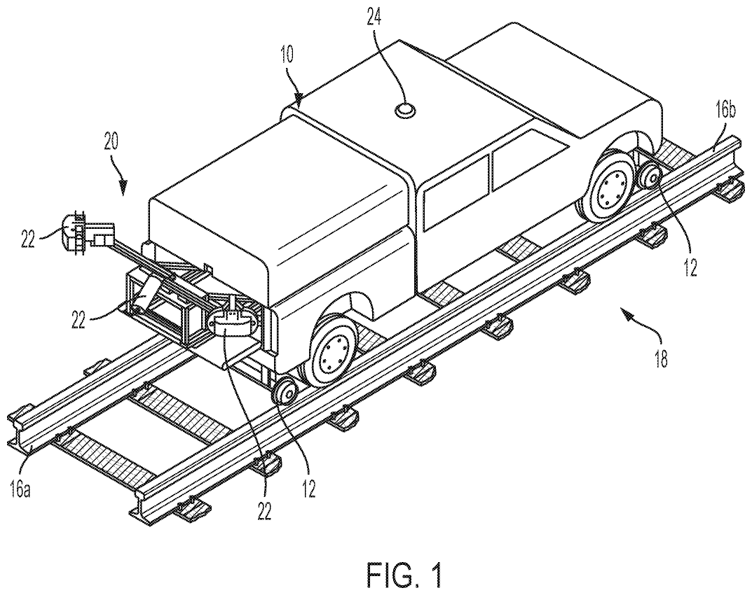

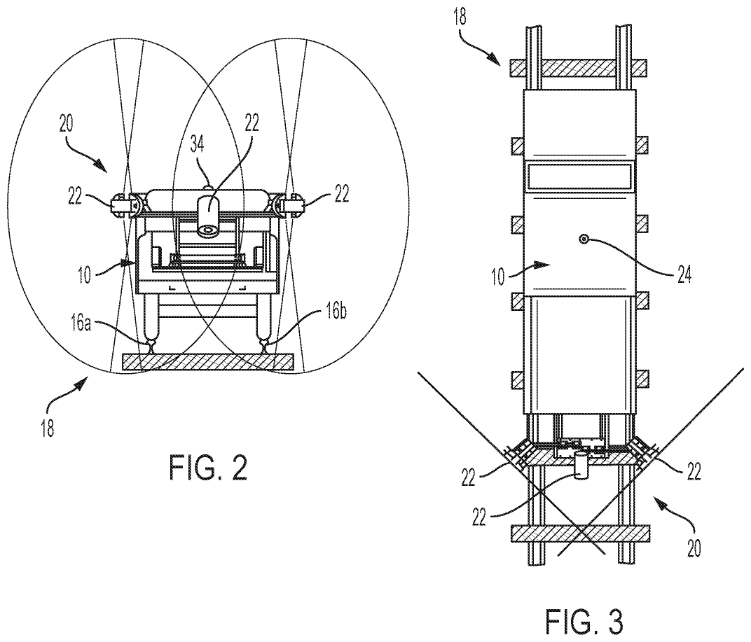

Looking to FIGS. 1 through 4, in an exemplary embodiment in accordance with the present invention, a survey vehicle operable to traverse a railroad track is designated generally by the numeral 10. The survey vehicle 10, is equipped with retractable flanged wheels 12 to enable it to travel along the left and right tracks 16a, 16b of a section of railway 18 being surveyed. The survey 10 is thus operable to travel over a section of track, multiple sections of track, or any combination of track sections where track asset detection is desired.

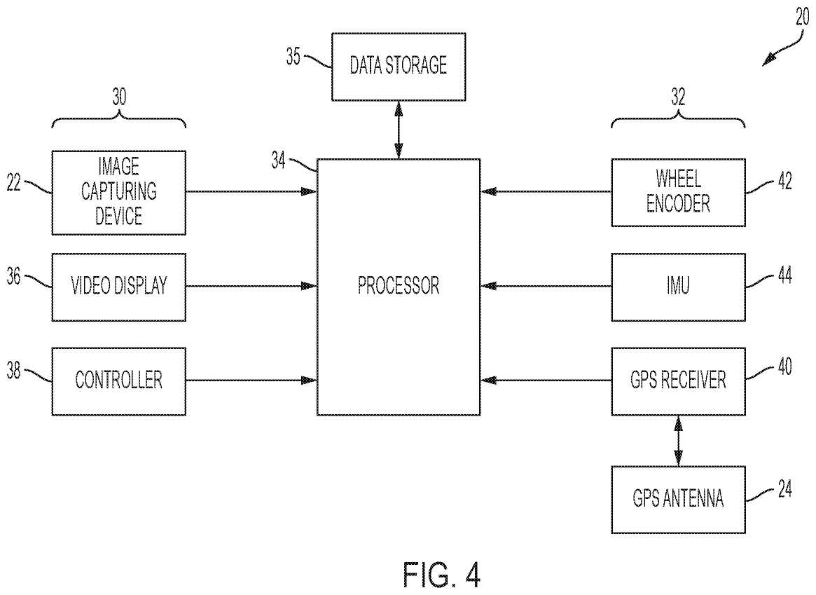

A survey system 20 attached to the survey vehicle 10 includes an image capture and recognition system 30 comprising a plurality of image capturing devices 22 for capturing images of the railroad track and the area surrounding the track (including railroad assets); a position determination system comprising a GPS antenna 24, for identifying the geolocation or position of the survey vehicle and/or assets in the vicinity of the survey vehicle, and a processor 34, as shown in FIG. 4, operable to process and analyze data captured via the image capturing devices in real-time to identify assets and to associate simultaneously captured positioning data from the position determination system with those identified assets, each of which systems will be described in more detail below. The processor 34, further stores the collected image and position data to a data storage unit 35, preferably in an accessible database format.

In alternative embodiments, the survey system 22 and/or the survey vehicle 10 may include communication equipment such a cellular telephone, radio, satellite communications devices, or other transponder, or may include Wi-Fi, Bluetooth, or other communications links, allowing the processor to communicate with and exchange information and data with remote processors, databases, or other information systems located on the survey vehicle, on other railroad cars or vehicles, or at other locations.

It should be understood that while the survey vehicle depicted in FIGS. 1 through 3 is a pickup truck adapted for use on a railroad track, the survey system 22 of the present invention may be used with other types of vehicles, such as a hi-rail vehicle, or may be mounted on a locomotive or train car so that image and position data is captured, and assets and their positions identified, in real-time during normal operation of those vehicles.

In further embodiments, the survey vehicle may be autonomous and deployed to traverse the desired track sections based on predetermined maps or guidance commands issued to the vehicle by a navigation system.

Regardless of the specific vehicle employed, the survey system 22, comprising an image capture and recognition system and a position determination system, is configured to operate unattended as the vehicle traverses the track, with the survey system capturing image and position data of the right of way area surrounding the track as the vehicle traverses along the track. In an exemplary embodiment, the survey system may be monitored or controlled by an operator such as a survey technician. Thus, for example, as seen in FIG. 4, the survey system may include a video display screen 36 for presenting a video stream to an operator, with identified assets highlighted or otherwise noted on the display screen. Regardless of whether monitored or not, once a route traversal is completed the database of assets and their locations is immediately available for use or review.

Looking again to FIG. 4, a block diagram of the survey system 20 is depicted. The survey system shows the image capture and recognition system 30 and the position determination system 32 each in communication with the processor 34, which is in further communication with a data storage unit 35.

Image capture and recognition system 30 preferably comprises one or more image capturing devices 22 as described above with respect to FIGS. 1 through 3, with each image capturing device 22 operable to capture video imagery of the track and the area surrounding the track, including railroad assets such as signals, switches, mile markers, road crossings and signs which are of particular relevance to PTC applications. In other railroad applications, assets such as station platforms, derails, and bungalows are assets of interest and will be captured and identified by the image recognition.

As described above with respect to FIGS. 1 through 3, each image capturing device 22 is attached in conjunction with the image capture and recognition system 30 to a survey vehicle, with each of the devices 22 aimed to capture a desired field of view from the survey vehicle. Each image capturing device 22 is in communication with the processor 34 so that digital images or representations of the captured images are available to the processor for analysis and detection of assets, and for storage of the captured images on the data storage unit 35. In alternative embodiments, the image capture and recognition system 30 may include one or more processors operable to process data from the image capturing devices 22 and to analyze and detect railroad assets within the captured images from the devices. The processor or processors in the image capture and recognition system may operate independently of the processor 34 or may work in conjunction with the processor 34. Similarly, the position determination system 32 may include one or more processors operable to capture and process GPS or other positional data, either independently of, or in conjunction with, processor 34. In further embodiments, processors in the image capture and recognition system 30 and/or in the position determination system 32 may be used instead of a separate coordinating processor 34. Thus, it should be understood that allocation of components between the image capture and recognition system 30, position determination system 32, and processor 34 may be arranged other than as shown in the exemplary embodiment of FIG. 4 without deviating from the scope of the present invention.

Image capturing devices 22 may be cameras, CCD devices, or other image capturing devices as known in the art, capable of capturing images using visible light or light outside the visible spectrum, such as infrared. The cameras may likewise be standard, spherical, wide angle, or other types known in the art. In alternative embodiments, the image capturing devices may be LiDAR scanners, radar, or other types of sensors capable of capturing images. Preferably, the image capturing devices are arranged to capture an entire field of view of the track and the area surrounding the track, generally at least the right-of-way associated with the track in which railroad assets or other assets of interest would be located.

When using multiple image capturing devices 22, the processor 34 preferably joins or stitches together the correlated images from the multiple devices to form a single image as is known in the art.

Image capture and recognition system 30 preferably further includes a video display 36 and controller 38 in communication with the processor 34. The video display allows an operator or a survey technician to view the image from any one of, or any combination of, the image capturing devices 22 in order to set-up the viewing field of the devices, or to view the images propagating from those devices during operation. Controller 38 provides input switches and controls to allow an operator or a survey technician to set-up and control various components and features of the survey system 22. The controller 38 may be integrated into the video display 36 or other component of the survey system 22 or may be a hardwired or wireless remote control in communication with the processor 34. In alternative embodiments where the survey system is deployed on an autonomously operated vehicle, the video display and/or the controller 38 may be omitted.

Position determination system 32 includes a GPS antenna 24 preferably mounted atop the survey vehicle 10, as described with respect to FIGS. 1 through 3, to provide an unobstructed view to the sky for reception of signals emanating from satellite systems providing geocoordinate positioning information signals to a Global Position determination systems (GPS) receiver 40 or other Global Navigation Satellite Systems (GNSS) receiver operable to identify the geolocation of the survey vehicle and/or assets in the vicinity of the vehicle and to provide the geolocation information to the processor 34.

The position determination system 32 further accepts data inputs from other position determining devices and sensors on the survey vehicle, including wheel encoders 42 and inertial measurement units (IMU) 44, as well as other position determining devices or sensors such as wheel tachometers or terrestrial navigation systems. In further embodiments, the position determination system may accept measurements from other known reference points to provide additional location information. The components and sensors of the position determination system 32 are in communication with the processor 34 to provide real-time position information that the processor correlates with assets identified by the image capture and recognition system 30.

Preferably, the processor 34 can use data from the IMU or other sensors to determine a change in position and orientation relative to a reference position in addition to GPS coordinate information provided by the GPS receiver 40, with position data from the GPS receiver periodically establishing or refreshing a new reference position for the IMU 44. In the event of failure or interruption of the GPS receiver, the IMU 44 and wheel encoder 42 may act as the primary position coordinate determining components. The positioning determining components preferably provide location or coordinate data to the processor 34 at regular intervals, in a steady stream, or upon request from the processor.

It should be understood that the components of image capture and recognition system 30, position determination system 32, processor 34, and data storage unit 35 may be mounted or positioned within housings or enclosures on the survey vehicle and may not be exposed or visible externally. For example, while the GPS antenna 24 and image capturing devices 22 are necessarily mounted such that they are visible externally to the vehicle (as depicted in FIG. 1), the other components, such as the processor 34, video display 36, controller 38, IMU 44, GPS receiver 40, wheel encoder 42, and data storage unit 35 (all as depicted in FIG. 4) may not be visible from the exterior of the vehicle, and may be placed as necessary or desired. For example, the wheel encoder 42 will typically be placed on a wheel of the survey vehicle, with the processor 34 and data storage unit 35 placed within an enclosure within the vehicle. Appropriate communication wiring or cabling between the various components will be apparent to those skilled in the art.

With the components of the survey system 22 set forth, an exemplary operation of the system in conjunction with a survey vehicle will now be described.

Referring still to FIG. 4, processor 34 is in communication with the image capture and recognition system 30 and the position determination system 32 as previously described, with the image capture and recognition system 30 providing a sequence of images from each image capturing device 22 to the processor and with the position determination system 32 providing geolocation coordinates indicating the position of the survey vehicle.

As the survey vehicle traverses the track, the images from the image capturing devices 22 of the image capture and recognition system 30 are received by the processor 34 along with position or coordinate data from the position determination system 32. The processor 34 in real-time analyzes and searches the imagery for recognizable assets of interest, including signals, switches, mile markers, road crossings, signs, platforms, derails, and bungalows. Preferably an image recognition engine running on the processor includes descriptions or maps of assets, with the processor applying that engine to identify desired assets. Upon identification or recognition of an asset, the processor preferably correlates the identified asset with a GPS coordinate or other location information from the position determination system 32. Preferably the position of the asset is determined by using a single frame of imagery correlated with position data, or by tracking the asset across multiple sequential frames to further refine the asset location.

Images from multiple image capturing devices 22 may be processed individually, or as discussed above may be stitched together to form a single composite image. Preferably, all identified asset imagery and locations are stored on the data storage unit 35, on the survey vehicle. A live video stream of image data may be presented by the processor 34 on the video display 36 for viewing by an operator as the vehicle travels. Identified assets may likewise be displayed on the video display 36. An operator may use controller 38 to start and stop the entire system 20, or to control and direct what is displayed on the video display 36. The operator may also use the controller and video display to review captured images and position data, or to review data files generated by the processor with image and positional data.

Simultaneously to the capture of imagery data, the position determination system captures data from the GPS receiver 40, IMU 44, wheel encoder 42, and any other positional sensors attached to the system. The processor 34 preferably analyzes and calculates geolocation from the multiple position sensor inputs. For example, an accurate geolocation may be calculated from the GPS signal combined with inputs from the wheel encoder and inertial measurement units to provide a more accurate positional signal than available from any of those individual sensors.

Preferably the processor 34 chronologically correlates the image data and the positional data using a time stamp or other correlation signal such that the geolocation of particular identified assets is ascertained. Most preferably, the processor and/or the image capture and recognition system 30 determines the positioning of assets in relation to the survey vehicle itself. For example, analysis of the image of an asset allows calculation of the distance and location of the asset in relation to the survey vehicle itself and/or to other located assets. Thus, the processor calculates the actual location of the asset by accounting for its offset in position from the survey vehicle.

Because the processor 34 and systems 30, 32 capture imagery and positional data in real-time and store the captured and processed data on the data storage unit 35, upon completion of a survey, the data file(s) identifying the assets and associated imagery, asset types, and asset locations are preferably immediately available for use on the vehicle, with no post processing of captured data required.

In addition, the captured, processed, and stored data files may also be transferred to a central server for long term storage, and for immediate use in updating track databases or PTC databases without the need for any post-processing as required in known asset recognition systems. In alterative embodiments where communications equipment is present on the survey vehicle as discussed above, the data files may be transmitted to a remote server for immediate use in updating track databases or PTC databases.

Thus, it can be seen that the system and method of the present invention provide benefits and features not present in the prior art and overcome problems with existing asset recognition systems. The system of the present invention may be used in conjunction with PTC activities such as PTC track surveys and PTC track database audit and verification, as well as with railroad maintenance activities and railroad asset audits.

In PTC applications, the database acquired from a track survey using the system of the present invention as just described may be used to generate or update PTC files, subdivision files, and the like. Combining the acquired database with additional non-visible data, such as subdivision name and wayside addresses, would yield a PTC-ready database.

For use in conjunction with a PTC track database audit, the system of the present invention is pre-loaded with a pre-existing PTC track database. During the audit survey or track traversal, the processor verifies the existence and location of each asset recorded in the pre-existing PTC track database, and further recognizes the existence of any assets not recorded in the pre-existing PTC track database.

The recognition of previously unidentified issues in combination with the verification of each asset recorded in the pre-existing PTC database allows the processor to provide notifications of deviations during the audit survey. At the conclusion of the audit run, the processor preferably has generated list of deviations between the real-world assets identified during the run and the assets in the pre-existing PTC track database. The processor then preferably creates an updated PTC track database based on the recognized assets. The updated PTC track database is available for immediate use and can be transmitted to a central server for deployment. In alternative embodiments, deviations detected by the processor may be reviewed and confirmed by a user before the deviations are updated into the PTC database.

It is to be understood that while certain forms of the present invention have been illustrated and described herein, it is not to be limited to the specific forms or arrangement of parts described and shown.

What is claimed and desired to be secured by Letters Patent is as follows:

1. A system for real-time asset recognition and location, comprising:
a survey system for attachment to a survey vehicle, the survey system operable to capture image data of an area surrounding the survey vehicle and corresponding position data;
a processor in communication with the survey system, the processor operable to analyze the captured image data and identify images of railroad assets and to correlate identified assets with a corresponding geolocation based on the position data in real-time as the survey vehicle traverses a section of track to be surveyed; and
a data storage unit in communication with the processor, the data storage unit operable to store: captured image data, captured position data, data from the processor identifying assets and their locations, and combinations thereof.

2. The system of claim 1, wherein the survey system comprises an image capture and recognition system and a positional location system.

3. The system of claim 2, wherein the image capture and recognition system comprises a plurality of image capturing devices.

4. The system of claim 3, wherein the image capturing devices comprise: cameras, CCD devices, LiDar scanners, radar scanners, or combinations thereof.

5. The system of claim 2, wherein the positional location system comprises: a GPS receiver, an inertial measurement unit, a wheel encoder, and combinations thereof.

6. The system of claim 1, wherein the processor compares captured image data to predefined image data corresponding to railroad assets to identify assets within the captured image data.

7. The system of claim 6, wherein the predefined image data corresponding dot railroad assets is stored on the data storage unit.

8. The system of claim 1, wherein the processor is further operable to transmit captured image data, captured position data, data identifying assets and their locations, and combinations thereof, to a remote server.

9. The system of claim 1, wherein the processor, once started, is operable to capture and analyze data and recognize railroad assets without further operator input.

10. The system of claim 1, further comprising a video display and a controller in communication with the processor, wherein the controller is operable to accept user input and the video display is operable to present information to a user.

11. A method for real-time asset recognition and location, comprising:
providing a survey system for attachment to a survey vehicle, the survey system operable to capture image data of an area surrounding the survey vehicle and corresponding position data;
providing a processor in communication with the survey system, the processor operable to analyze the captured image data and identify images of railroad assets and to correlate identified assets with a corresponding geolocation based on the position data in real-time as the survey vehicle traverses a section of track to be surveyed; and
providing a data storage unit in communication with the processor, the data storage unit operable to store: captured image data, captured position data, data from the processor identifying assets and their locations, and combinations thereof.

12. The method of claim 11, wherein the survey system comprises an image capture and recognition system and a positional location system.

13. The method of claim 12, wherein the image capture and recognition system comprises a plurality of image capturing devices.

14. The method of claim 12, wherein the image capturing devices comprise: cameras, CCD devices, LiDar scanners, radar scanners, or combinations thereof.

15. The method of claim 12, wherein the positional location system comprises: a GPS receiver, an inertial measurement unit, a wheel encoder, and combinations thereof.

16. The method of claim 11, wherein the processor compares captured image data to predefined image data corresponding to railroad assets to identify assets within the captured image data.

17. The method of claim 16, wherein the predefined image data corresponding dot railroad assets is stored on the data storage unit.

18. The method of claim 11, wherein the processor is further operable to transmit captured image data, captured position data, data identifying assets and their locations, and combinations thereof, to a remote server.

19. The method of claim 11, wherein the processor, once started, is operable to capture and analyze data and recognize railroad assets without further operator input.

20. The method of claim 11, further comprising a video display and a controller in communication with the processor, wherein the controller is operable to accept user input and the video display is operable to present information to a user.
